(19) United States
(12) Patent Application Publication
(10) Pub. No.: US 2004/0266233 A1
(43) Pub. Date: Dec. 30, 2004

(54) Electrical connector assembly with readily removable pick-up cap

(76) Inventor: Yao-Chi Huang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/877,718

(22) Filed: Jun. 25, 2004

(30) Foreign Application Priority Data
Jun. 25, 2003 (TW) 92211554

(51) Int. Cl. H01R 13/44

(52) U.S. Cl. 439/135

(57) ABSTRACT

An electrical connector assembly (1) comprises an electrical connector (2) and a pick-up cap (3) mounted onto the connector. The connector (2) includes an insulative housing (20) having two opposite sidewalls(200, 201) thereon and a multiplicity of terminals (21) received therein. The pick-up cap includes a base portion (30), and first and second extending portions (31, 32) extending from opposite ends of the base portion respectively. A first and second clasps (312, 321) respectively depends from a corresponding distal end of the first and second extending portions. A first and second latching arms (313, 322) interconnects distal ends of the corresponding first and second clasps. The housing defines a first and second latching protrusions (2003, 2013) on an inside of the sidewalls corresponding to the first and second latching arms, respectively.

### BACKGROUND OF THE INVENTION

1. Field of the Invention

The present invention relates to an electrical connector assembly which comprises an electrical connector and a pick-up cap, the pick-up cap being mounted onto the connector for providing a plane top surface to be engaged by a vacuum suction device, whereby the connector assembly can be moved to a circuit substrate such as a printed circuit board (PCB) on which the electrical connector is to be mounted.

2. Description of the Prior Art

As electronics technology continually develops, manual assembly in mass production facilities is being steadily replaced by automated assembly. In general, automated attachment of an electrical connector onto a printed circuit board (PCB) involves a vacuum pick-up device that picks up the electrical connector from one position and places it in another position. U.S. Pat. Nos. 6,413,111, 5,681,174, 5,651,684, 5,249,977 and 5,026,295 show that the electrical connector needs to have a plane top surface in order for it to be reliably engaged by the vacuum pick-up device. An article entitled “MicroPGA Packages” (CONNECTOR SPECIFIER, May 2000, pp.16˜18) discloses an electrical connector for an electronic device. The connector defines a rectangular through hole in a center thereof for dissipating heat produced by the electronic device. Therefore, the connector cannot be directly engaged by a vacuum pick-up device. Generally, the connector is provided with a pick-up cap, so that the combination can be engaged by the vacuum pick-up device.

Referring to FIGS. 6 and 7, a conventional electrical connector assembly 6 comprises an electrical connector 8 and a pick-up cap 9 mounted on the connector 8. The connector 8 comprises an insulative housing 80, and a multiplicity of electrical terminals 81 received in the housing 80. The housing 80 is substantially a rectangular substrate, and is formed from dielectric material such as LCP (liquid crystal polymer) that can endure soldering temperatures. The housing 80 defines a rectangular cavity 801 in a middle portion thereof for receiving an electrical package such as a central processing unit (CPU) therein, and comprises a pair of parallel, opposite sidewalls 800. A multiplicity of terminal-passages 803 is defined in a portion of the housing 80 around the cavity 801, for receiving a corresponding number of the terminals 81 therein. Two latching protrusions 8000 are defined on outside middle portions of the sidewalls 800 respectively. A cross-section of each latching protrusion 8000 is generally triangular.

The pick-up cap 9 includes a base portion 91 having a plane top surface, and a first extending portion 92 and a second extending portion 93 extending from opposite ends of the base portion 91 respectively. The first and second extending portions 92, 93 are for being received on the sidewalls 800 respectively. The first extending portion 92 comprises two parallel first arms 920, for being engaged on a corresponding one of the sidewalls 800. The second extending portion 93 comprises two parallel second arms 930, for being engaged on the other sidewall 800. A connecting portion 921 interconnects distal ends of the first arms 920, for facilitating a user in releasing the pick-up cap 9 from the connector 8. A pair of first clasps 922 depends from the distal ends of the first arms 920 respectively. A first latching arm 923 interconnects distal ends of the first clasps 922. The first clasps 922 and the first latching arm 923 cooperatively define a first socket 924 therebetween, for receiving a corresponding one of the latching protrusions 8000 of the housing 80 therein. A pair of second clasps 931 depends from distal ends of the second arms 930 respectively. A second latching arm 932 interconnects distal ends of the second clasps 931. The second clasps 931 and the second latching arm 932 cooperatively define a second socket 933 therebetween, for receiving the other latching protrusion 8000 of the housing 80 therein.

In assembly, the pick-up cap 9 is placed on the connector 8, with the first and second latching arms 923, 932 loosely resting on the corresponding sidewalls 800 respectively. Then, the pick-up cap 9 is pressed down. The first and second latching arms 923, 932 are deflected outwardly, and respectively ride along outer faces of the latching protrusions 8000 until the latching protrusions 8000 are received in the first and second sockets 924, 933 respectively. The pick-up cap 9 is thereby securely mounted onto the connector 8. A nozzle of the vacuum suction device (not shown) can then engage the plane surface of the base portion 90, in order to move the connector assembly 6 to a desired location on a PCB.

In the above-described assembly process, the latching protrusions 8000 are formed on respective outer faces of the sidewalls 800, and are engaged in the first and second sockets 924, 933. When the pick-up cap 9 is detached from the housing 80, a user applies force on the connecting portion 921 of the pick-up cap 9. This force is typically in an inclined direction, as indicated by arrow F in FIG. 7. Force F comprises the component force Fx acting along a direction parallel to the pick-up cap 9, and the component force Fy acting perpendicularly upwardly relative to force Fx. The effect of force Fx is to make the engagement between the pick-up cap 9 and the housing 80 tighter. As a result, it is difficult to detach the second latching arm 923 from the corresponding latching protrusion 8000. The force F applied on the connecting portion 921 needs to be considerable in order to be able to detach the pick-up cap 9 from the connector 8.

Thus, there is a need to provide a new electrical connector assembly that overcomes the above-mentioned disadvantages.

### SUMMARY OF THE INVENTION

Accordingly, one main object of the present invention is to provide an electrical connector assembly which has an electrical connector and a pick-up cap mounted on the connector, wherein the pick-up cap can be readily detached from the connector.

To fulfill the above-mentioned object, an electrical connector assembly in accordance with a preferred embodiment comprises an electrical connector and a pick-up cap mounted on the electrical connector. The connector includes an insulative housing and a multiplicity of terminals received therein. The housing has four raised sidewalls and the four sidewalls cooperatively define a generally rectangular space therebetween for receiving an electronic package such as a central processing unit (CPU) therein. Two opposite sidewalls respectively define a central mounting portion therein. A first and second latching protrusions respectively is formed on an corresponding inside of the two opposite central portion. A cross-section of the first and second latching protrusions are generally triangular. The pick-up cap includes a base portion, a first and a second extending portions extending from opposite ends of the base portion respectively. The first extending portion comprises two parallel first arms. A connecting portion interconnects distal ends of the first arms, for facilitating a user in releasing the pick-up cap from the connector. A pair of first and second clasps respectively depends from the corresponding distal ends of the first and second extending portions. A first and second latching arms respectively interconnects the corresponding distal ends of the first and second clasps. The first clasps and the first latching arm cooperatively define a first latching socket therebetween, and the second clasps and the second latching arm cooperatively define a second latching socket therebetween, for receiving the corresponding first and second latching protrusions therein.

In the assembly process, the latching protrusions are formed on respective inner faces of the sidewalls, and are engaged in the first and second latching sockets. When the pick-up cap is subsequently detached from the connector, a user applies force F on the connecting portion of the pick-up cap. The force is typically in an inclined direction. Force F comprises a component force Fx acting along a direction parallel to the pick-up cap, and a component force Fy acting vertically upwardly. The component force Fx operates to disengage the first latching protrusion of the housing from the first latching socket of the pick-up cap. The component force Fy operates to remove the first latching arm of the pick-up cap up from the first latching protrusion. Therefore the force F that needs to be applied by the user on the connecting portion is less than that required for conventional electrical connector assemblies, which facilitates convenient detachment of the pick-up cap from the connector.

Other objects, advantages and novel features of the present invention will become more apparent from the following detailed description when taken in conjunction with the accompanying drawings, in which:

### BRIEF DESCRIPTION OF THE DRAWINGS

FIG. 1 is a simplified, exploded, isometric view of an electrical connector assembly in accordance with the preferred embodiment of the present invention, the connector assembly comprising an electrical connector and a pick-up cap mountable onto the connector;

FIG. 2 is an assembled view of FIG. 1;

FIG. 3 is similar to FIG. 1, but viewed from another aspect;

FIG. 4 is an assembled view of FIG. 3;

FIG. 5 is a cross-sectional view taken along line V-V of FIG. 2;

FIG. 6 is a simplified, exploded, isometric view of a conventional electrical connector assembly; and

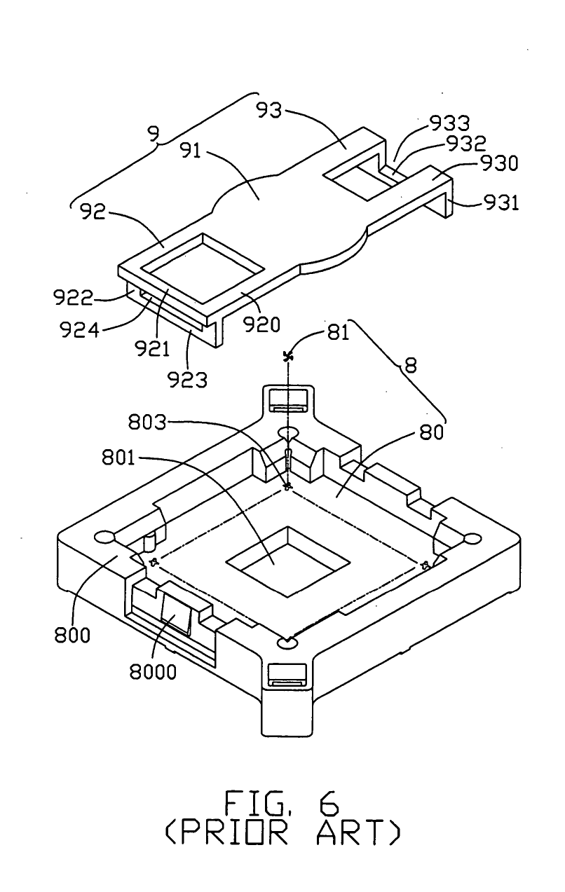

FIG. 7 is an assembled view of FIG. 6.

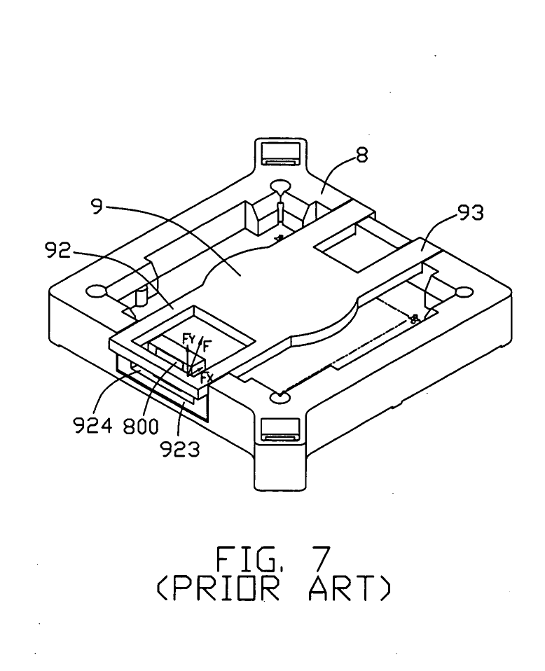

### DESCRIPTION OF PREFERRED EMBODIMENTS OF THE INVENTION

Reference will now be made to the drawings to describe the present invention in detail.

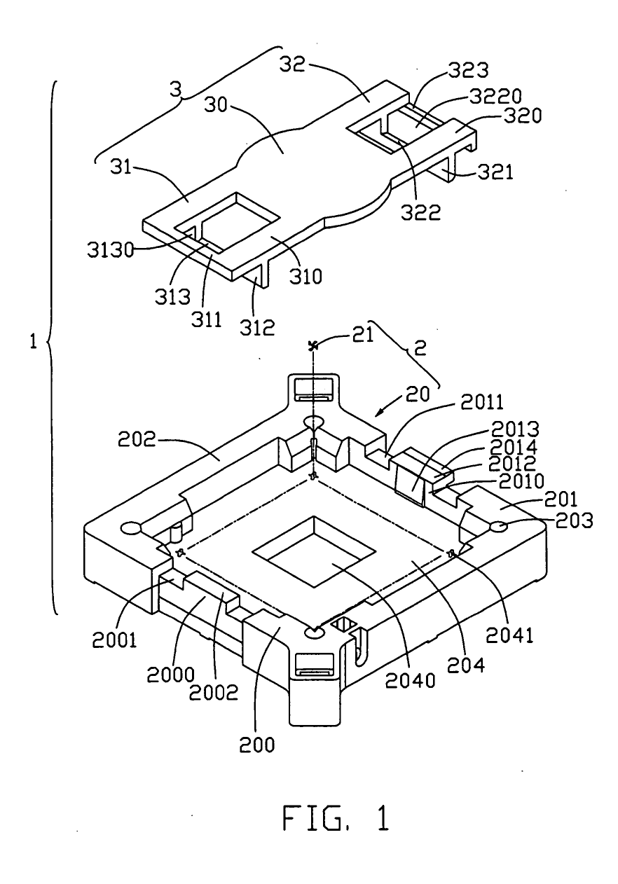

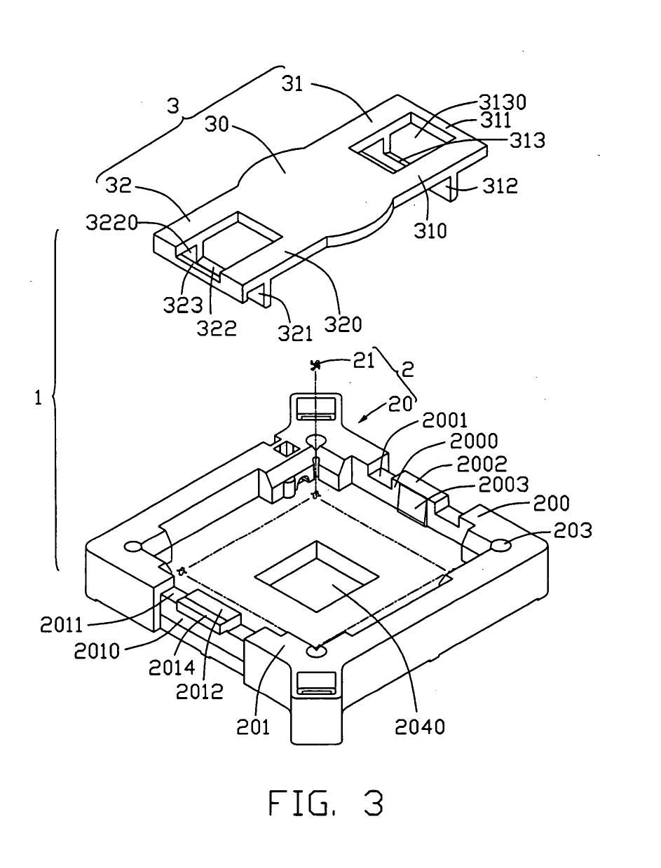

FIGS. 1 and 3 each show a simplified, exploded isometric view of an electrical connector assembly 1 in accordance with the preferred embodiment of the present invention. The electrical connector assembly 1 comprises an electrical connector 2 and a pick-up cap 3. The pick-up cap 3 is mounted onto the connector 2, for providing a plane surface to be engaged by a vacuum suction device (not shown). The electrical connector assembly 1 can thereby be moved to a circuit substrate, such as a printed circuit board (PCB) (not shown), on which the connector 2 is to be mounted.

The connector 2 comprises an insulative housing 20, and a multiplicity of terminals 21 received in the housing 20. The housing 20 is substantially a rectangular substrate, and is formed from dielectric material such as LCP (liquid crystal polymer) that can endure soldering temperatures. The housing 20 comprises a base 204, a first sidewall 200, a second sidewall 201 opposite to the first sidewall 200, and two opposite third sidewalls 202 interconnecting the first and second sidewalls 200, 201. The base 204 and the first, second and third sidewalls 200, 201, 202 cooperatively define a space therebetween for receiving a CPU package (not shown) therein. The base 204 defines a rectangular cavity 2040 in a middle thereof. A multiplicity of terminal-passages 2041 is defined in the base 204 around the cavity 2040, for receiving a corresponding number of the terminals 21 therein. The first and second sidewalls 200, 201 respectively define central first and second mounting portions 2000, 2010 therein, for receiving the pick up cap 3 thereon. The first and second mounting portions 2000, 2010 respectively comprise raised first and second central portions 2002, 2012. A pair of recessed first receiving portions 2001 is defined in the first mounting portion 2000 at opposite sides of the first central portion 2002 respectively. A pair of recessed second receiving portions 2011 is defined in the second mounting portion 2010 at opposite sides of the second central portion 2012 respectively. The second central portion 2012 comprises a lip 2014 extending outwardly therefrom. A first latching protrusion 2003 is formed on an inside of the first central portion 2002. A cross-section of the first latching protrusion 2003 is generally triangular. A second latching protrusion 2013 is formed on an inside of the second central portion 2012. A cross-section of the second latching protrusion 2013 is generally triangular. Four circular holes 203 are defined in four comers of the housing 20 respectively, for insertion of fasteners (not shown) therethrough in order to mount the connector 2 onto the PCB.

The pick-up cap 3 comprises a base portion 30 having a plane top surface, and first and second extending portions 31, 32 extending from opposite ends of the base portion 30 respectively. The first extending portion 31 comprises two parallel first arms 310, for being received in the first receiving portions 2001 of the housing 20. The second extending portion 32 comprises two parallel second arms 320, for being received in the second receiving portions 2011 of the housing 20. A first connecting portion 311 interconnects distal ends of the first arms 310, for facilitating a user in releasing the pick-up cap 3 from the connector 2. A pair of first clasps 312 depends from the distal ends of the first arms 310 respectively. A first latching arm 313 interconnects distal ends of the first clasps 312. The first clasps 312 and the first latching arm 313 cooperatively define a first latching socket 3130 therebetween, corresponding to the first latching protrusion 2003 of the first sidewall 200. A second connecting portion 323 perpendicularly interconnects undersides of distal ends of the second arms 320. The second connecting portion 323 corresponds to the lip 2014 of the second sidewall 201. A pair of second clasps 321 depends from the distal ends of the second arms 320 respectively. A second latching arm 322 interconnects distal ends of the second clasps 321. The second clasps 321, the second latching arm 322 and the second connecting portion 323 cooperatively define a second latching socket 3220 therebetween, for receiving the second latching protrusion 2013 therein.

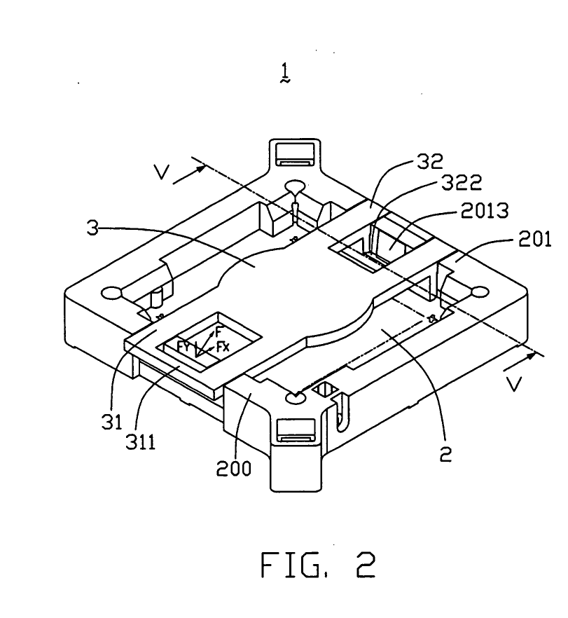

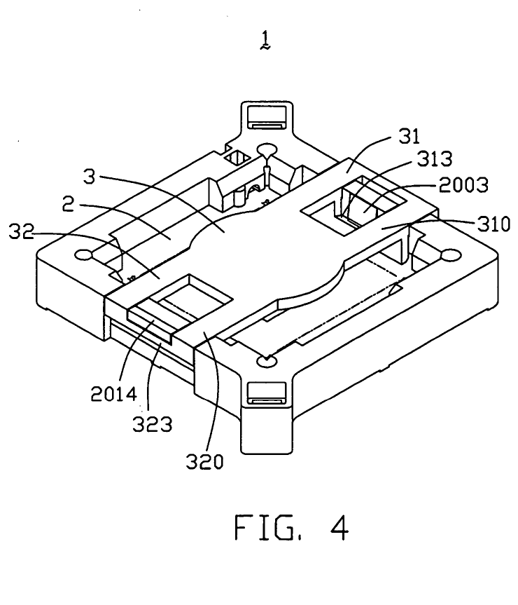

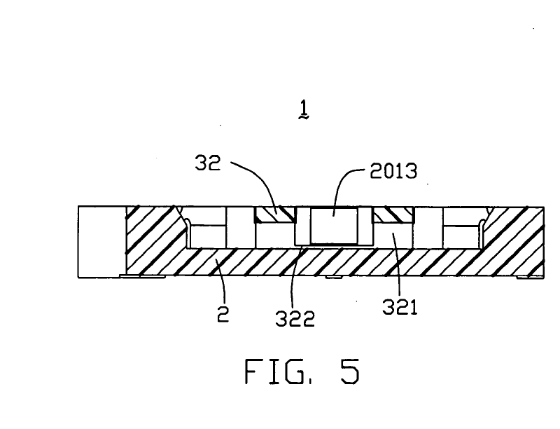

Referring to FIGS. 1-5, in assembly of the electrical connector assembly 1, the pick-up cap 3 is placed on the connector 2, with the first and second arms 310, 320 loosely resting on the first and second receiving portions 2001, 2011 respectively. Then the pick-up cap 3 is pressed down. The first latching arm 313 rides along an outer face of the first latching protrusion 2003 until the first latching protrusion 2003 is snappingly received in the first latching socket 3130. Simultaneously, the second latching arm 322 rides along an outer face of the second latching protrusion 2013 until the second latching protrusion 2013 is snappingly received in the second latching socket 3220 and the second connecting portion 323 is engaged with the lip 2014 of the second central portion 2012. The pick-up cap 3 is thereby securely mounted onto the connector 2. A nozzle of the vacuum suction device (not shown) can then engage the plane surface of the base portion 30, in order to move the connector assembly 1 to a desired location on the PCB.

When the pick-up cap 3 is subsequently detached from the connector 2, a user applies force on the first connecting portion 311 of the pick-up cap 3. This force is typically in an inclined direction, as indicated by arrow F in FIG. 3. Force F comprises a component force Fx acting along a direction parallel to the pick-up cap 3, and a component force Fy acting vertically upwardly. The component force Fx operates to disengage the first latching protrusion 2003 of the housing 20 from the first latching socket 3130 of the pick-up cap 3. The component force Fy operates to remove the first latching arm 313 of the pick-up cap 3 up from the first latching protrusion 2003. Therefore the force F that needs to be applied by the user on the first connecting portion 311 is less than that required for conventional electrical connector assemblies, which facilitates convenient detachment of the pick-up cap 3 from the connector 2.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical connector assembly comprising:
an electrical connector comprising:
an insulative housing defining a plurality of sidewalls adapted for receiving an electronic package therein, at least one of the sidewalls defining a latching protrusion on an inner face thereof; and
a plurality of terminals received in the housing;
a pick-up cap mounted on the housing and comprising:
a base portion having a planar top surface to be sucked by a vacuum suction device; and
at least one extending portion extending from one end of the base portion;
wherein the at least one extending portion defines at least one mating member mating with the latching protrusion to reduce the force applied on the pick up cap during detachment of the pick-up cap from the connector.

2. The electrical connector assembly of claim 1, wherein the at least one extending portion comprises two parallel arms.

3. The electrical connector assembly of claim 2, wherein the extending portions comprise a first extending portion and a second extending portion opposite to the first extending portion.

4. The electrical connector assembly of claim 2, wherein the arms comprise a first arm and a second arm opposite the first arm.

5. The electrical connector assembly of claim 4, wherein the mating member comprises a first clasp and a second clasp depending from the corresponding distal ends of the first and second arms and a first connecting portion interconnecting distal ends of the first arms.

6. The electrical connector assembly of claim 5, wherein a second connecting portion perpendicularly interconnects undersides of distal ends of the second arms.

7. The electrical connector assembly of claim 5, wherein a first latching arm and a second latching arm respectively interconnects distal ends of the first and the second clasps.

8. The electrical connector assembly of claim 7, wherein the first clasps and the first latching arm cooperatively define a first latching socket.

9. The electrical connector assembly of claim 7, wherein the second clasps, the second latching arm and the second connecting portion cooperatively define a second latching socket.

10. The electrical connector assembly of claim 1, wherein a cross-section of the latching protrusion is generally triangular.

11. The electrical connector assembly of claim 10, wherein the latching protrusions comprise a first latching protrusion and a second latching protrusion corresponding to the first and second latching sockets.

12. The electrical connector assembly of claim 11, wherein the housing defines a first mounting portion and a second mounting portion corresponding to the first and second extending portions.

13. The electrical connector assembly of claim 12, wherein the housing defines a first receiving portion and a second receiving portion corresponding to the first and second arms.

14. The electrical connector assembly of claim 12, wherein the second mounting portion defines a raised central portion.

15. The electrical connector assembly of claim 14, wherein the second central portion comprises a lip extending outwardly therefrom corresponding to the second connecting portion.

16. An electrical connector assembly comprising:
an electrical connector comprising:
an insulative housing defining a plurality of sidewalls adapted for receiving an electronic package therein, at least one of the sidewalls defining a latching protrusion on an inner face thereof; and
a plurality of terminals received in the housing;
a pick-up cap mounted on the housing and comprising:
a base portion having a planar top surface to be sucked by a vacuum suction device; and
at least one extending portion extending from one end of the base portion and essentially out of an outer face of said at least one of the side walls;
wherein the at least one extending portion defines at least one mating member mating with the latching protrusion to reduce the force applied on the pick up cap during detachment of the pick-up cap from the connector

17. An electrical connector assembly comprising:
an electrical connector comprising:
an insulative housing defining a plurality of sidewalls adapted for receiving an electronic package therein, at least one of the sidewalls defining a latching protrusion on an inner face thereof and a lip on the outer face thereof; and
a plurality of terminals received in the housing;
a pick-up cap mounted on the housing and comprising:
a base portion having a planar top surface to be sucked by a vacuum suction device; and
at least one extending portion extending from one end of the base portion;
wherein the at least one extending portion defines a first mating member mating with the latching protrusion and a second mating member mating with the lip.

18. The assembly of claim 17, wherein the second mating member is shorter than the first mating member for rotative assembling of said cap to the housing.
